(19) United States
(12) Patent Application Publication
(10) Pub. No.: US 2011/0113464 A1
(43) Pub. Date: May 12, 2011

(54) SET-TOP BOX AND ELECTRONIC DEVICE AND METHOD FOR IMPROVING MONITORING QUALITY THEREOF

(75) Inventor: LUNG DAI, Tu-Cheng (TW)

(73) Assignee: HON HAI PRECISION INDUSTRY CO., LTD., Tu-Cheng (TW)

(21) Appl. No.: 12/768,550

(22) Filed: Apr. 27, 2010

(30) Foreign Application Priority Data
Nov. 12, 2009 (CN) 200910309636.3

(51) Int. Cl. H04N 7/173; H04N 5/93

(52) U.S. Cl. 725/132; 386/E05.003

(57) ABSTRACT

A set-top box includes a receiving unit, a processing unit, a transmitting unit, and a capturing unit. The receiving unit is adapted to receive an external signal from an external signal source. The processing unit is adapted to improve the quality of the video signal in the external signal. The transmitting unit is adapted to transmit the processed external signal to a display device such that the processed external signal is reproduced by the display device. The capturing unit adapted to capture video images of a monitored area. The processing unit further improves the quality of the captured video images.

### BACKGROUND

1. Technical Field

The present disclosure relates to methods for improving monitoring qualities, and particularly to set-top boxes and electronic devices using the methods.

2. Description of Related Art

For security, many people commonly install a camera in their home. The camera is often connected to a display. The camera captures images of a monitored area and then transmits the captured images to the display for viewing. However, the quality of the video images directly displayed on the display is often low.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the two views.

FIG. 1 is a block diagram of a set-top box in accordance with an exemplary embodiment.

FIG. 2 is a flowchart of a method for improving monitoring quality in accordance with an exemplary embodiment.

### DETAILED DESCRIPTION

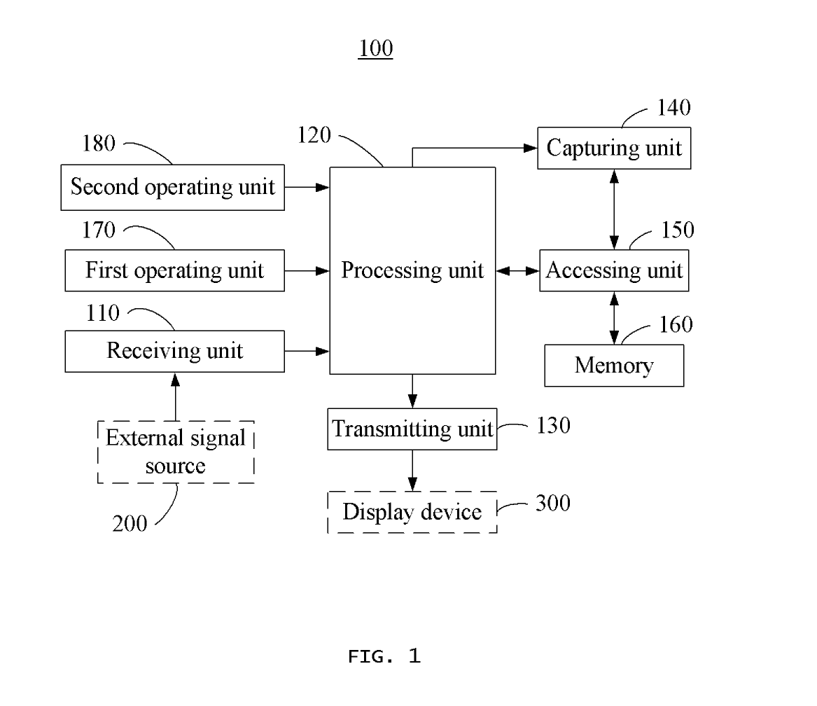

Referring to FIG. 1, a set-top box 100 is commonly connected between an external signal source 200 and a display device 300. The display device 300 may be a television. The set-top box 100 is used for processing an external signal received from the external signal source 200 and transmitting the processed external signal to the display device 300.

The set-top box 100 includes a receiving unit 110, a processing unit 120, a transmitting unit 130, a capturing unit 140, an accessing unit 150, a memory 160, and a first operating unit 170.

The receiving unit 110 is used for receiving an external signal from the external signal source 200. The external signal commonly includes a video signal and an audio signal. In the embodiment, the external signal may be a broadcast television signal.

The processing unit 120 is used for improving quality of the video signal in the external signal. In the embodiment, the processing unit 120 estimates motion of the video signal in the external signal first, and then compensating the motion of the video signal in the external signal according to the estimated motion, thus the quality of the video signal in the external signal are improved. The processing unit 120 may also be used for decoding and demodulating the external signal.

The transmitting unit 130 is used for transmitting the processed external signal to the display device 300, such that the display device 300 reproduces the processed external signal, thus users can view a higher resolution video.

The capturing unit 140 is used for capturing video images of a monitored area to monitor events happening in the monitored area. In the embodiment, the capturing unit 140 may be a camera.

The accessing unit 150 is electrically connected between the capturing unit 140 and the memory 160. The accessing unit 140 is used for storing the captured video images in the memory 160 for a user to access later. In the embodiment, the memory 160 may be a hard disk.

The first operating unit 170 is used for generating a reproduced signal in response to a user. The first operating unit 170 may be a first key arranged on the set-top box 100. The reproduced signal is generated when the first key is pressed down.

The processing unit 120 is also used for controlling the accessing unit 150 to obtain the captured video images from the memory 160, and improving quality of the captured video images in response to the reproduced signal.

The transmitting unit 130 is also used for transmitting the processed video images to the display device 300, such that the display device 300 can reproduce the processed video images, thus the user can view higher resolution video images. Therefore, monitoring quality is enhanced by the use of the set-top box 100.

The set-top box 100 also includes a second operating unit 180. The second operating unit 180 is used for generating an operating signal in response to a user's operation. In the embodiment, the second operating unit 180 may be a second key arranged on the set-top box 100. The operating signal is generated when the second key is pressed down.

The processing unit 120 is also used for enabling the capturing unit 140 in responses to the operating signal such that the capturing unit 140 is capable of capturing the video images of the monitored area. In addition, when a user is at home, the capturing unit 140 can be disabled, thus energy can be saved.

It is noteworthy that the set-top box 100 can be replaced with other electronic device such as a computer, or a media player.

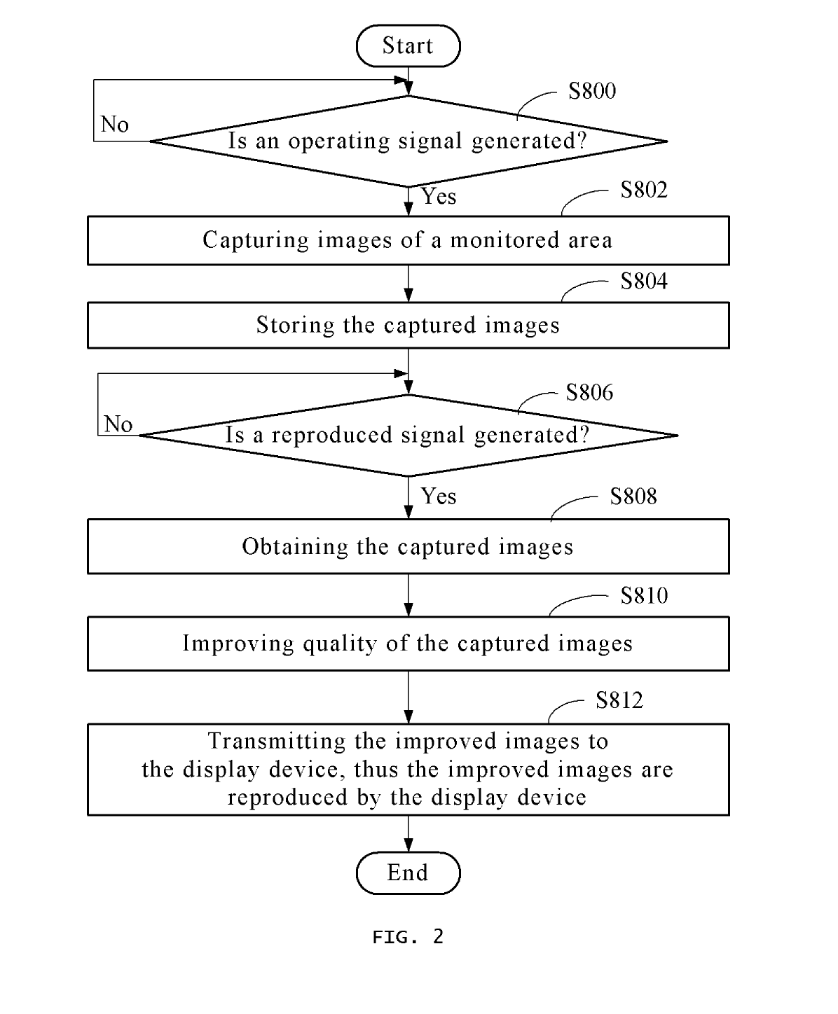

Referring to FIG. 2, a method for improving monitoring quality is provided. The method may be applied in a set-top box capable of capturing video images. The method includes the following steps:

In step S800, determining whether an operating signal is generated. If the operating signal is determined to be generated, step S802 is implemented. If the operating signal is determined not to be generated, step S800 is implemented again. In the embodiment, the set-top box has a first key. The operating signal is generated when the first key is pressed down.

In step S802, capturing video images of a monitored area to monitor events happening in the monitored area. In the embodiment, if the set-top box is located in a house, events happening in the house may be monitored.

In step S804, storing the captured video images to be accessed by a user later. In the embodiment, the set-top box has a memory for storing the captured video images. The memory may be a hard disk.

In step S806, determining whether a reproduced signal is generated. If the reproduced signal is determined to be generated, step S808 is implemented. If the reproduced signal is determined not to be generated, step S806 is implemented again. In the embodiment, the set-top box has a second key. The reproduced signal is generated when the second key is pressed down.

In step S808, obtaining the captured video images.

In step S810, improving the quality of the captured video images by estimating motion of the captured video images first, and then compensating the motion of the captured video images according to the estimated motion.

In step S812, transmitting the improved video images to a display device such that the display device 300 can reproduce the improved video images, therefore, the user can view higher resolution video images. Therefore, the monitoring quality is enhanced. In the embodiment, the display device may be a television.

It is noteworthy that the method for improving the monitoring quality can be applied in other electronic devices such as a computer, or a media player.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A set-top box, comprising:
a receiving unit adapted to receive an external signal from an external signal source;
a processing unit adapted to improve quality of a video signal in the external signal;
a transmitting unit adapted to transmit the processed external signal to a display device such that the processed external signal is reproduced by the display device; and
a capturing unit adapted to capture video images of a monitored area;
wherein the processing unit further improves quality of the captured video images.

2. The set-top box according to claim 1, wherein the transmitting unit further transmits the processed video images to the display device such that the processed video images are reproduced by the display device.

3. The set-top box according to claim 1, further comprising:
a memory; and
an accessing unit adapted to store the captured video images in the memory.

4. The set-top box according to claim 3, further comprising:
a first operating unit adapted to generate a reproduced signal in response to a user's operation;
wherein the accessing unit further obtains the captured video images from the memory and transmits the captured video images to the processing unit in response to the reproduced signal.

5. The set-top box according to claim 1, further comprising:
a second operating unit adapted to generate an operating signal in response to a user's operation;
wherein the processing unit further enables the capturing unit in response to the operating signal such that the capturing unit is capable of capturing the video images of the monitored area.

6. The set-top box according to claim 1, wherein the processing unit improves the qualities of the captured video images by estimating motion of the captured video images, and compensating the motion of the captured video images according to the estimated motion.

7. A method for improving monitoring quality implemented by an electronic device, the electronic device comprising a capturing unit, the method comprising:
capturing video images of a monitored area; and
improving quality of the captured video images.

8. The method according to claim 7, further comprising:
storing the captured video images.

9. The method according to claim 8, further comprising:
determining whether a reproduced signal is generated; and
if the reproduced signal is determined to be generated, obtaining the captured video images, and the step that improving the quality of the captured video images is further implemented.

10. The method according to claim 9, further comprising:
if the reproduced signal is determined not to be generated, repeating the step of determining whether the reproduced signal is generated.

11. The method according to claim 7, further comprising:
determining whether an operating signal is generated; and
if the operating signal is determined to be generated, the step that capturing the video images of the monitored area is implemented.

12. The method according to claim 11, further comprising:
if the operating signal is determined not to be generated, repeating the step of determining whether the operating signal is generated.

13. The method according to claim 7, wherein the quality of the captured video images is improved by estimating motion of the captured video images, and compensating the motion of the captured video images according to the estimated motion.

14. An electronic device, comprising:
a capturing unit adapted to capture video images of a monitored area; and
a processing unit is adapted to improve quality of the captured video images.

15. The electronic device according to claim 14, further comprising a transmitting unit adapted to transmit the processed video images to a display device such that the processed video images are reproduced by the display device.

16. The electronic device according to claim 14, further comprising:
a memory; and
an accessing unit adapted to store the captured video images in the memory.

17. The electronic device according to claim 16, further comprising:
a first operating unit adapted to generate a reproduced signal in response to a user's operation;
wherein the accessing unit further obtains the captured video images from the memory and transmits the captured video images to the processing unit in response to the reproduced signal.

18. The electronic device according to claim 14, further comprising:
a second operating unit adapted to generating an operating signal in response to a user's operation;
wherein the processing unit further enables the capturing unit in response to the operating signal such that the capturing unit is capable of capturing the video images of the monitored area.

19. The electronic device according to claim 14, wherein the processing unit improves the quality of the captured video images by estimating motion of the captured video images, and compensating the motion of the captured video images according to the estimated motion.
